(19) United States
(12) Patent Application Publication
(10) Pub. No.: US 2026/0362218 A1
(43) Pub. Date: Nov. 12, 2026

(54) UL BITRATE CONTROL WITH MOBILITY SUPPORT

(71) Applicant: InterDigital Patent Holdings, Inc., Wilmington, DE (US)

(72) Inventors: Magurawalage Chathura Madhusanka SARATHCHANDRA, London (GB); Michael Starsinic, Newtown, PA (US); Rocco Di Girolamo, Laval (CA)

(73) Assignee: InterDigital Patent Holdings, Inc., Wilmington, DE (US)

(21) Appl. No.: 19/202,138

(22) Filed: May 8, 2025

(51) Int. Cl. H04W 28/02

(52) U.S. Cl. CPC H04W 28/0268; H04W 28/0257; H04W 28/0273

(57) ABSTRACT

A method performed by a wireless transmit / receive unit (WTRU) may comprise: receiving, from a session management function (SMF), one or more quality of service (QoS) rules associated with a QoS flow, wherein the one or more QoS rules include an indication that that uplink rate control is supported for the QoS flow and bitrate configuration information associated with the QoS flow; receiving, from a radio access network (RAN), a message indicating that uplink rate control is activated for the QoS flow; determining a maximum allowable uplink bitrate for the QoS flow; and adjusting, based on the maximum allowable uplink bitrate, one or more application layer parameters associated with an application mapped to the QoS flow.

### BACKGROUND

For extended reality (XR) rate control, RAN2 assumes that the base station receives quality of service (QoS) flow information from the core network, indicating which QoS flows are subject to uplink rate control. In some wireless system,, handover procedures are controlled by the network and are categorized into two types of mobility: cell-level mobility, and beam-level mobility. Cell-level mobility involves changes between different cells and requires explicit radio resource control (RRC) signaling to be initiated.

### SUMMARY

A method performed by a wireless transmit / receive unit (WTRU) may comprise: receiving, from a session management function (SMF), one or more quality of service (QoS) rules associated with a QoS flow, wherein the one or more QoS rules include an indication that that uplink rate control is supported for the QoS flow and bitrate configuration information associated with the QoS flow; receiving, from a radio access network (RAN), a message indicating that uplink rate control is activated for the QoS flow; determining a maximum allowable uplink bitrate for the QoS flow; and adjusting, based on the maximum allowable uplink bitrate, one or more application layer parameters associated with an application mapped to the QoS flow.

The method may also include, determining bitrate of data transmitted in the QoS flow and, on a condition that the bitrate of the data transmitted is greater than the maximum allowable uplink bitrate, discarding at least some data. The method may further include receiving, from the RAN, a handover request, including an indication that uplink rate control for the QoS flow is deactivated and adjusting, based on the indication, one or more application layer parameters associated with an application mapped to the QoS flow. The handover request may indicates if a target RAN supports uplink rate control. Furthermore, the method may include reactivating uplink rate control for the QoS flow upon completion of a handover from the RAN to a target RAN.

The one or more QoS rules may include an application identifier that identifies an application associated with the QoS flow. The application identifier may indicates that all traffic associated with the identifies application is mapped to the QoS flow. The bitrate configuration information may include a plurality of bitrate values and corresponding index values. The message received from the RAN may include the maximum allowable bitrate or an index value. The bitrate configuration information may include the maximum allowable bitrate.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates as exemplary inter-base station handover procedure;

FIG. 3 illustrates an example uplink data rate control and date rate indication procedure; and

FIG. 4 illustrates an example flow chart for an uplink data rate control and date rate indication procedure.

### DETAILED DESCRIPTION

The following acronyms and abbreviations may be referred to:
5GSM 5G Session Management
ACK Acknowledgement
AF Application Function
AMF Access and Mobility Management Function
AN Access Network
AS Application Server
BS Base Station
CDRX Connected Mode Discontinuous Reception
CHO Conditional Handover
CL Classifier
CM Connection Management
CN Core Network
CSI-RS Channel State Information Reference Signal
DAPS Dual Active Protocol Stack
DL Downlink DN Data Network
DNAI Data Network Access Identifier
EoB End of Burst
HO Handover
ISF Integrated Sensing Function
MAC Media Access Control
MAC CE MAC Control Element
ME Mobile Equipment
MT Mobile Termination
PCC Policy and Charging Control
Pcell Primary Cells
PCF Policy Control Function
PDPC Packet Data Convergence Protocol
PDU Protocol Data Unit
PSA PDU Session Anchor
QoE Quality of Experience
QoS Quality of Service
RAN Radio Access Network
RRC Radio Resource Control
SDF Service Data Flow
SDP Session Description Protocol
SMF Session Management Function
SSB Synchronization Signal Block
SSC Session and Service Continuity
SSCMSP SSC mode selection policy
TE Terminal Equipment
TSC Time-sensitive communications
TSN Time-sensitive networking
TTL Time To Live
UE User Equipment
UL Uplink
UPF User Plane Function
URLLC Ultra-Reliable and Low Latency Communications
XR Extended Reality

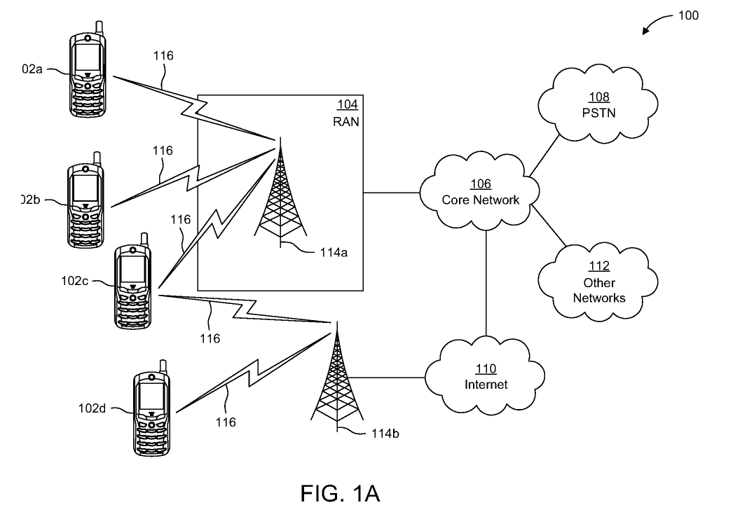

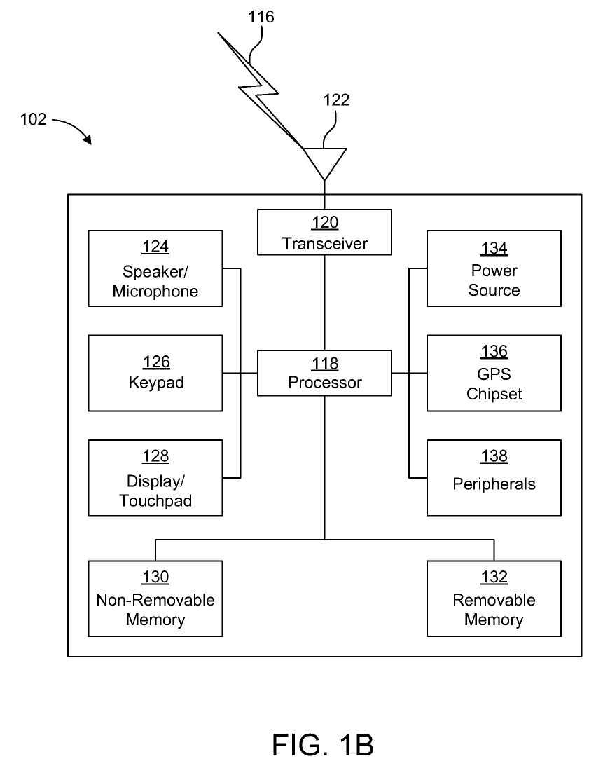

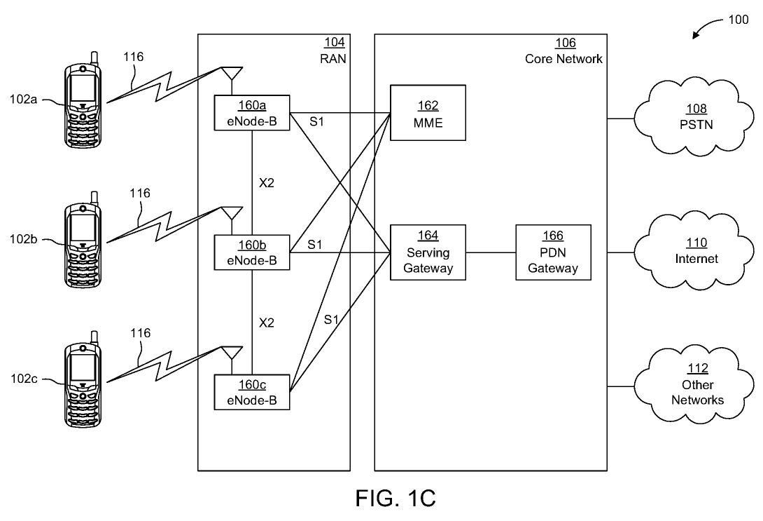

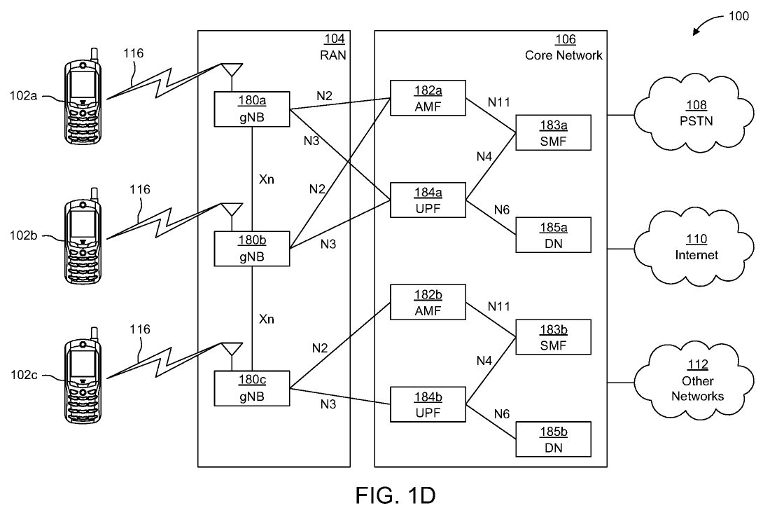

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102cand 102d may be interchangeably referred to as a UE.

The communications systems 100 may also include a base station 114aand/or a base station 114b. Each of the base stations 114a, 114bmay be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114aand/or the base station 114bmay be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114amay include three transceivers, i.e., one for each sector of the cell. In an embodiment, the base station 114amay employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using NR.

In an embodiment, the base station 114a and the WTRUs 102a, 102b, 102c may implement multiple radio access technologies. For example, the base station 114aand the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114band the WTRUs 102c, 102d may implement a radio technology such as IEEE 802.15 to establish a wireless personal area network (WPAN). In yet another embodiment, the base station 114band the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102dto access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102dmay include multiple transceivers for communicating with different wireless networks over different wireless links). For example, the WTRU 102cshown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160cmay each include one or more transceivers for communicating with the WTRUs 102a, 102b, 102c over the air interface 116. In one embodiment, the eNode-Bs 160a, 160b, 160cmay implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102cwith access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102cwith access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180cmay each include one or more transceivers for communicating with the WTRUs 102a, 102b, 102c over the air interface 116. In one embodiment, the gNBs 180a, 180b, 180cmay implement MIMO technology. For example, gNBs 180a, 108bmay utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180cmay implement Coordinated Multi-Point (CoMP) technology. For example, WTRU 102amay receive coordinated transmissions from gNB 180a and gNB 180b(and/or gNB 180c).

The WTRUs 102a, 102b, 102c may communicate with gNBs 180a, 180b, 180cusing transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180cusing subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180cwithout also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180cusing signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182bin the CN 106 via an N11 interface. The SMF 183a, 183bmay also be connected to a UPF 184a, 184bin the CN 106 via an N4 interface. The SMF 183a, 183b may select and control the UPF 184a, 184band configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102cwith access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102cwith access to the other networks 112, which may include other wired and/or wireless networks that are owned and/or operated by other service providers. In one embodiment, the WTRUs 102a, 102b, 102cmay be connected to a local DN 185a, 185bthrough the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In 5G systems, handover procedures are controlled by the network and are categorized into two types of mobility: (1) cell-level mobility, and (2) beam-level mobility. Cell-level mobility involves changes between different cells and requires explicit RRC signaling to be initiated. This includes inter-BS handovers.

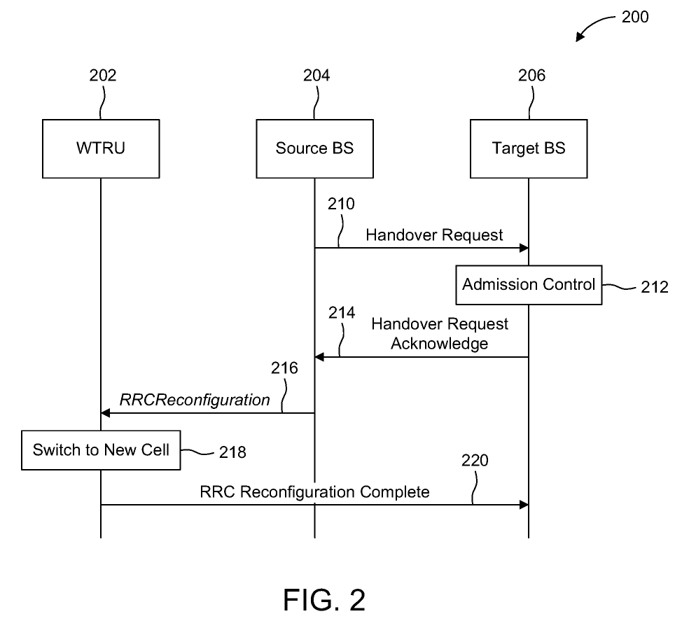

FIG. 2 illustrates as inter-BS handover procedure 200. At 210, the source BS 204 may initiate a handover procedure by sending a handover request to the target BS 206. The handover request may be over an Xn Interface.

At 212, the target BS 206 may perform admission control to determine whether it can support the incoming WTRU 202. At 214, the target BS 206 may send a handover request acknowledgement to the source BS 204. The handover request acknowledgement may include a new RRC configuration for the WTRU 202.

At 216, the source BS 204 may send a RRCReconfiguration message to the WTRU 202. The RRCReconfiguration message may include at least a cell ID and all information required to access the target cell (e.g., beam specific information). At 218, the WTRU 202 performs the handover and switches to the target cell. At 220, the WTRU 202 may send a RRCReconfigurationComplete message to the target BS 206.

When supporting intra-NR RAN handover procedures, messages may be directly exchanged between the BSs via the Xn interface (e.g., for transferring the WTRU context from source BS 204 to target BS 206). Resources at the source BS are released once the handover completion phase is triggered by the target BS.

In conventional HO procedures, a WTRU releases the connection to the source cell before establishing connectivity to the target cell, terminating uplink and downlink transmissions. This release may cause an interruption to the services in the range of few tens of milliseconds (e.g., 30 – 60 milliseconds). Dual Active Protocol Stack (DAPS) addresses the release issue.

During handover, DAPS enables the WTRU to maintain simultaneous connectivity to both the source cell and the target cell, with only PCells involved. This dual connectivity persists for a short transition period, allowing the WTRU to continue uplink and downlink user data transmission with the source cell until the target cell is ready to fully take over. Once the random access procedure with the target cell is completed, uplink user data transmission is switched to the target cell.

A common Packet Data Convergence Protocol (PDCP) entity may be configured for both the source and target cells to ensure continuity of PDCP sequence numbering, enabling in-sequence delivery of user data across the handover. During the handover, downlink user data is forwarded from the source cell to the target cell. The source cell may transmit the data to the WTRU until the handover is completed, while the target cell may buffer the forwarded data for delivery post-handover. Once the handover is successfully completed, uplink data transmission may be fully switched to the target cell, and the source cell stops downlink transmission after receiving confirmation of successful handover from the target cell. If the handover fails, the WTRU may reverts to the source cell.

A conditional handover (CHO) is a mobility procedure executed by a WTRU based on a CHO configuration received from the network, designed to reduce handover failures, particularly for users in motion. Upon receiving the CHO configuration, the WTRU begins evaluating predefined execution conditions and discontinues the evaluation once a handover is completed. Unlike conventional handover procedures that prepare a single target cell, CHO involves the preparation of multiple candidate target cells in advance. This allows the handover command to be delivered while radio conditions are still favorable, thereby mitigating the risk of handover failure caused by deteriorating link quality. The CHO configuration, typically generated by the source BS, may include a list of candidate target cells and corresponding execution conditions. These execution conditions may comprise one or more trigger criteria, such as measurements of SSB and/or CSI-RS.

In 5G systems, uplink rate control may be performed by the RAN (e.g., NG-RAN) on a per-QoS flow basis. For example, in scenarios involving network congestion, the RAN may implement data rate control by recommending a reduced data rate to the WTRU. Once uplink rate control is enabled, the RAN may indicate the available uplink data rate to the WTRU for each supported QoS flow, using signaling such as a MAC CE or an RRC message.

When uplink bitrate control is activated for a given QoS flow, it may be necessary for the 5G system to coordinate this rate control with the application(s) whose data traffic is multiplexed onto the QoS flow. Without such coordination, the WTRU’s lower protocol layers may discard excess application data, while the application layer remains unaware of the reason for the transmission failure, leading to degraded user experience.

Additionally, uplink rate control may be influenced by operator policies and user subscription profiles. To support this, the 5G system must introduce appropriate signaling procedures whereby the CN informs the RAN which QoS flows are subject to uplink rate control.

A few issues include: (1) how to ensure the RAN is informed about applications and QoS flows subject to uplink rate control; (2) how to enable WTRU applications to receive and react to uplink rate information; and (3) how to handle situations in which previously indicated uplink rate values become invalid due to a handover to another RAN node. The embodiments described herein provide mechanisms for enabling uplink bitrate control and for handling scenarios involving uplink bitrate control during handover events.

The described embodiments allow the RAN node to transmit a notification to the WTRU indicating activation of uplink bitrate control, upon determining that uplink bitrate control is required. This notification enables the WTRU to perform necessary adjustments to its uplink transmission behavior. Furthermore, in the event of a handover, the RAN node may include uplink rate control-related information in the handover request message. For example, the RAN node may indicate that the last reported uplink rate indication is no longer valid, such as in cases where the handover is directed to a RAN node that does not support the uplink rate control feature. In some scenarios, the RAN node may transmit an indication to the WTRU prior to the handover, informing the WTRU that the uplink rate control feature is deactivated.

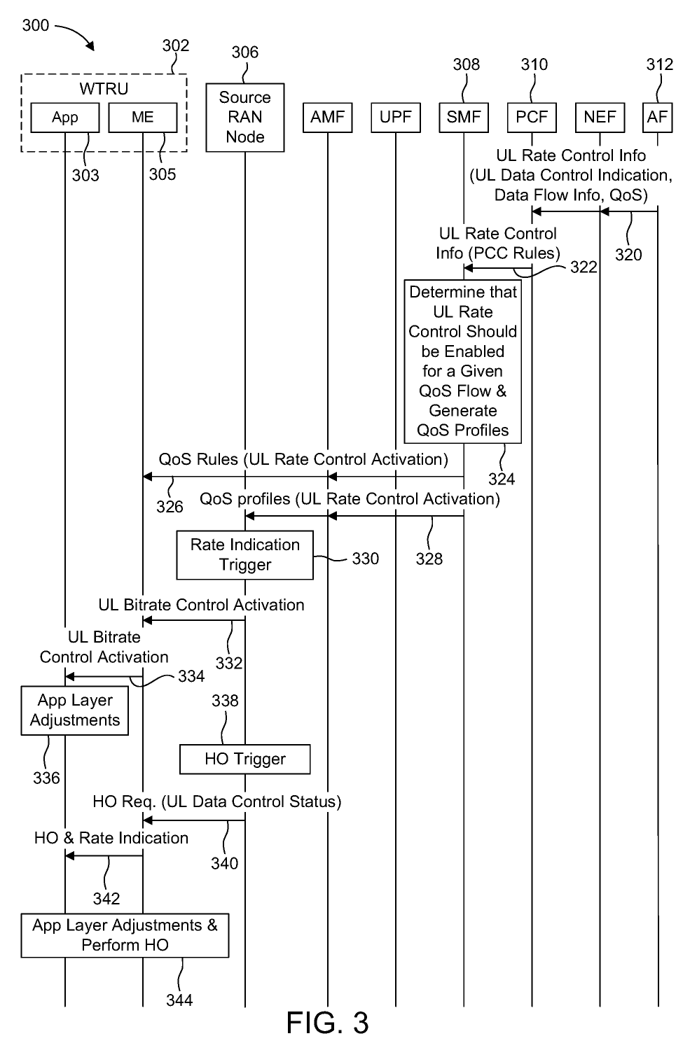

FIG. 3 provides an example procedure 300 for uplink data rate control and date rate indication. As shown in FIG. 3, the WTRU 304 may include an application layer 303 and mobile equipment (ME) 305. The ME 305 may incorporate the components shown in FIG. 1B. Furthermore, as provided in FIG. 3, the RAN node 306 may be a source RAN node (i.e., currently serving node).

At 320, AF 312 may transmit an uplink data rate control indication message to PCF 310. The uplink data rate control indication may include information related to the associated data flows, such as data flow identifiers and QoS requirements, which may be subject to uplink data rate adjustments by the network (e.g., 5G System). AF 312 may transmit this information by invoking the Nnef_AFsessionWithQoS service.

The uplink data rate control indication message may specify that only the data flows of a single application should be multiplexed onto a QoS flow for which uplink rate control is enabled. This message may result from a negotiation between the WTRU 302 and an AS, such as through the use of SDP, to determine whether the uplink data rate control feature should be applied to specific QoS flows. As part of the message, the AF 312 may provide specific bitrate ranges or qualitative bitrate levels (e.g., high, medium, low), which may be associated with index values to facilitate reference and signaling.

At 322, the PCF 310 may generate PCC rules based on information received from the AF 312 or from local configuration(s). The PCC rules may include information related to uplink data rate control and the associated data flows. The PCF 310 may then send the PCC rules to the SMF 308. A PCC rule may include an indication that uplink bitrate control is active for the application associated with the rule. In some cases, all SDFs linked to the PCC rule may correspond to the same application operating on the WTRU.

At 324, the SMF 308 may determine, based on information contained in the PCC rules, that uplink data rate control is to be enabled for one or more QoS flows. SMF 308 may identify the data flows that are eligible to be multiplexed into a single QoS flow, and in some cases, may determine that only data flows associated with a single application should be mapped to a given QoS flow. SMF 308 may then generate QoS rules for WTRU 302 and QoS profiles for RAN node 306, both of which indicate that uplink data rate control is enabled for the corresponding QoS flows.

At 326, SMF 308 may send the QoS rules generated at 324 to WTRU 302. These QoS rules may include an indication that uplink rate control is supported for one or more associated QoS flows. The message carrying the QoS rules may be sent during the establishment and/or modification of the corresponding QoS flows, such as during PDU session establishment or PDU session modification. The message may include an indication that WTRU 302 may receive uplink bitrate control activation messages from RAN node 306 (e.g., as described at 332 below) when the feature is activated. Additionally, the message may include the necessary configuration information to enable WTRU 302 to receive and process such activation messages from RAN node 306.

Further at 326, SMF 308 may use the PCC rules to generate QoS rules. If a PCC rule includes an indication that uplink bitrate control is supported for the traffic associated with the PCC rule, then SMF 308 may map that traffic to a dedicated QoS flow, and not map traffic associated with any other PCC rules to the same QoS flow. As a result, the QoS flow may be configured to carry traffic for a single application only, specifically the application whose traffic is subject to uplink bitrate control.

An advantage of mapping the traffic of only one application to the QoS flow when uplink bitrate control is enabled for the application is that a one-to-one mapping between a QoS flow and application is created. Thus, when the network activates uplink bitrate control for a QoS flow, WTRU 302 is be able to determine for what application uplink bitrate control should be activated.

SMF 308 may then transmit the QoS rules to WTRU 302. The NAS-SM message used to send the QoS rules may include an indication of which QoS rule(s) support activation of uplink bitrate control. Additionally, the NAS-SM message may carry uplink bitrate information, such as a bitrate limit that WTRU 302 should apply when the network indicates that uplink bitrate control is active. The NAS-SM message may also include an Application Identifier, which indicates to WTRU 302 that all traffic associated with that Application Identifier is linked to a specific QoS rule. Accordingly, WTRU 302 may map all traffic associated with the Application Identifier to the QoS flow corresponding to that QoS rule.

At 328, the SMF 308 may transmit the QoS profiles generated at 324 to RAN node 306. These QoS profiles may include an indication that uplink rate control is supported for one or more QoS flows. The message may be sent during the establishment and/or modification of the corresponding QoS flows, such as during PDU session establishment or PDU session modification.

At 330, RAN node 306 may trigger a rate indication message to one or more WTRUs associated with QoS flows for which the uplink rate control feature is enabled. The rate indication may be triggered by various events, including, but not limited to, network congestion. For example, RAN node 306may determine that the uplink data rate should be adjusted for one or more QoS flows. This determination may be based on information received from UPFs. In one example, a PSA UPF experiencing congestion may signal the RAN to temporarily reduce the uplink bitrate for certain flows, such as by a specified percentage (e.g., K%).

At 332, RAN node 306 may transmit a message to WTRU 302 that includes an indication that uplink bitrate control is activated for a particular QoS flow. This message may specify the uplink bitrate limit that the WTRU 302 should apply to the QoS flow.

In addition to the bitrate limit, the message may include further parameters related to the uplink rate control. These parameters may include an indication of the reason for the data rate change, such as a network condition or event that triggered the RAN’s decision to adjust the uplink rate, as described at 330. The message may also specify the duration for which the new bitrate should be applied, for example by including a timer value, after which WTRU 304 may revert to the previously configured bitrate. Furthermore, if the rate adjustment is intended to take effect at a later time, the message may include timing information indicating when the change should be applied.

At 334, based on the indication that uplink rate control is activated for a QoS flow, ME 305 may determine the maximum allowable bitrate for that QoS flow. This determination may be based on the bitrate value indicated by RAN node 306 at the time uplink rate control was activated. Alternatively, ME 305 may determine the maximum bitrate from information received in the NAS-SM message. In some cases, ME 305 may compute the bitrate using a combination of information from both the NAS-SM message and the message received from the RAN node 306 at 332. For example, the NAS-SM message may include a set of predefined bitrate values along with associated index values, and the message received at 332 may specify one of those index values, allowing WTRU 302 to identify the corresponding maximum bitrate to apply.

ME 305 may also measure the bitrate of data that is being sent in the QoS flow. If ME 305 determines that the bitrate of the data matches or exceeds the maximum allowed bitrate of the QoS flow, then ME 305 may discard data so that the volume of data that is sent to RAN node 306 (i.e. over the air) does not exceed the maximum allowed bitrate.

The ME 305 may also send a message to the application 303 that is associated with the QoS flow. For example, the ME 305 may send a message to the application 303 whose traffic is mapped to the QoS flow. The message may indicate to application 303 that uplink bitrate control is active, and the message may include the maximum allowed bitrate for the QoS Flow. Application 303 may run in the TE part of WTRU 302. The message that is used to send the notification and maximum allowed bitrate for the QoS Flow to application 303 may be an AT Command.

As described in 332, the message received from the network may include information specifying the duration for which uplink bitrate control is active. Accordingly, the notification sent by ME 305 to application 303 may inform application 303 of the time period during which it should assume that uplink bitrate control remains active. This allows application 303 to manage its uplink traffic accordingly, without requiring an additional deactivation message from the network or ME 305, thereby reducing signaling overhead.

Additionally, the network message may specify the activation time of uplink bitrate control. In such cases, the notification from ME 305 to application 303 may indicate when the application 303 should assume that uplink bitrate control becomes active. This enables the network and ME 305 to schedule uplink bitrate control activation in advance, based on predicted network conditions, allowing application 303 to proactively adjust its behavior.

At 336, application 303 may perform application-layer adjustments based on the information received at 334. For instance, if application 303 is a video streaming application, it may reduce the quality of the uplink video—such as by modifying video codec settings—to ensure that the resulting uplink bitrate remains below the maximum allowable bitrate. This prevents the ME 305 from having to discard excess data, thereby preserving transmission efficiency and application performance.

At 338, RAN node 306 may trigger a handover procedure. As part of this process, RAN node 306 may determine whether to deactivate the uplink rate control feature. Where possible, RAN node 306 may select a target RAN node that supports uplink data rate control. If the selected target RAN node supports this feature, RAN node 306 may include information about the QoS flows for which uplink rate control is enabled in the handover signaling. Additionally, RAN node 306 may provide the latest uplink bitrate indications for those QoS flows. The uplink rate control activation status may also be taken into account when performing service data flow (SDF) admission control at the target RAN node. For example, in scenarios where the overall uplink capacity must be limited, the target RAN node may consider that the uplink data rate for certain QoS flows can be reduced, thereby improving resource management efficiency.

At 340, WTRU 302 may receive a HO request message from RAN node 306. The HO request message may be a RRCReconfiguration message. The HO request message may include an indication of whether the uplink rate control feature is to be turned on or off. It may also indicate whether the target RAN node supports uplink rate control, and whether RAN node 306 has provided the target RAN node with information about QoS flows for which uplink rate control is enabled. Additionally, the HO request message may include an indication of whether the latest uplink data rate values for those QoS flows have been communicated to the target RAN node. Alternatively, the completion of the handover procedure itself may trigger WTRU 302 to deactivate uplink rate control unless or until the new RAN node (e.g., the target RAN node) reactivates it.

At 342, ME 305 may forward information from the handover request message received at 340 to application 303 associated with QoS flows for which uplink data rate control is enabled. For example, the ME 305 may notify application 303 that uplink rate control is no longer active, based on the completion of the handover procedure. Uplink rate control may be reactivated by the target RAN node after the handover, if the target RAN node supports the feature. However, if the target RAN node does not support uplink rate control, then the feature will remain deactivated while the WTRU 302 is being served by that node.

At 344, the application may perform any application-layer adaptations required for operation under the target RAN node, and WTRU 302 may proceed with the handover to the target RAN node. For example, based on the information received in the message at 340, WTRU 302 may deactivate uplink rate control for the relevant QoS flows and notify the application that uplink rate control will not be available after the handover is completed.

In one embodiment, a WTRU may receive QoS rules from an SMF indicating that uplink rate control is permitted to be enabled (i.e., activated) for one or more QoS flows. The QoS rules may specify that a particular QoS flow should carry traffic associated with a single application, identified by an Application Identifier, and that the traffic for this application is subject to uplink bitrate control.

The WTRU may subsequently receive a message from a RAN node indicating that uplink bitrate control is activated for a specific QoS flow. This message may include the uplink bitrate limit to be applied to the QoS flow. Alternatively, the applicable bitrate limit may have been provided earlier in a NAS message used to deliver the QoS rules to the WTRU.

Based on the indication that uplink bitrate control is active for the QoS flow, the ME may determine the maximum allowable bitrate for the QoS flow. If the ME determines that the data rate of the application traffic meets or exceeds this maximum, it may discard data as necessary to ensure that the volume of data transmitted to the RAN node does not exceed the allowed bitrate. Additionally, the ME may send a message to the application associated with the QoS flow, informing it that uplink bitrate control is active and providing the applicable maximum bitrate value.

The WTRU may then perform application-layer adjustments based on the received bitrate control information received from the RAN node. For example, the application may adapt by modifying video codec settings to reduce the generated uplink bitrate, thereby remaining within the allowed limit.

The completion of a handover procedure may cause the WTRU to deactivate uplink rate control, unless the new serving RAN node (e.g., the target RAN node) re-enables the feature. Alternatively, the WTRU may receive a handover-related message, such as an RRCReconfiguration message from the source RAN node, indicating that a handover is being initiated. This message may specify that uplink rate control is to be deactivated, either temporarily or until explicitly reactivated by the target RAN node. It may also include an indication of whether the target RAN node supports the uplink rate control feature.

The ME may forward the information received in connection with the handover to the one or more applications associated with QoS flows that have uplink data rate control enabled. Based on this information, the one or more applications may perform the necessary adaptations for operation under the target RAN. For example, the WTRU may deactivate uplink rate control for the relevant QoS flows upon completion of the handover.

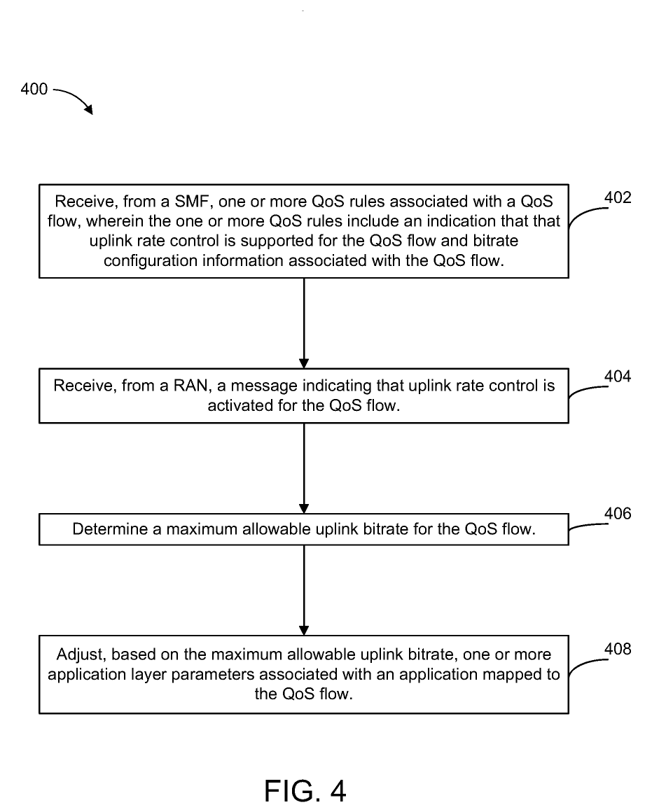

FIG. 4 illustrates an exemplary procedure performed by a WTRU for uplink data rate control and data rate indication. At 402, the WTRU may receive, from a SMF, one or more QoS rules associated with a QoS flow, wherein the one or more QoS rules include an indication that uplink rate control is supported for the QoS flow and bitrate configuration information associated with the QoS flow.

At 404, the WTRU may receive, from a RAN, a message indicating that uplink rate control is activated for the QoS flow. At 406, the WTRU may determine a maximum allowable uplink bitrate for the QoS flow. At 408, the WTRU may adjust, based on the maximum allowable uplink bitrate, one or more application layer parameters associated with an application mapped to the QoS flow.

The procedure 400 may also include, determining bitrate of data transmitted in the QoS flow and, on a condition that the bitrate of the data is greater than the maximum allowable uplink bitrate, discarding at least some data. The procedure 400 may further include receiving, from the RAN, a handover request, including an indication that uplink rate control for the QoS flow is deactivated and adjusting, based on the indication, one or more application layer parameters associated with an application mapped to the QoS flow. The handover request may indicates if a target RAN supports uplink rate control. Furthermore, the procedure 400 may include reactivating uplink rate control for the QoS flow upon completion of a handover from the RAN to a target RAN.

The one or more QoS rules may include an application identifier that identifies an application associated with the QoS flow. The application identifier may indicates that all traffic associated with the identifies application is mapped to the QoS flow. The bitrate configuration information may include a plurality of bitrate values and corresponding index values. The message received from the RAN may include the maximum allowable bitrate or an index value. The bitrate configuration information may include the maximum allowable bitrate.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit / receive unit (WTRU), the method comprising:
receiving, from a session management function (SMF), one or more quality of service (QoS) rules associated with a QoS flow, wherein the one or more QoS rules include an indication that that uplink rate control is supported for the QoS flow and bitrate configuration information associated with the QoS flow;
receiving, from a radio access network (RAN), a message indicating that uplink rate control is activated for the QoS flow;
determining a maximum allowable uplink bitrate for the QoS flow; and
adjusting, based on the maximum allowable uplink bitrate, one or more application layer parameters associated with an application mapped to the QoS flow.

2. The method of claim 1, wherein the one or more QoS rules include an application identifier that identifies an application associated with the QoS flow.

3. The method of claim 2, wherein the application identifier indicates that all traffic associated with the identified application is mapped to the QoS flow.

4. The method of claim 1, wherein the bitrate configuration information includes a plurality of bitrate values and corresponding index values.

5. The method of claim 1, wherein the message received from the RAN includes the maximum allowable bitrate or an index value.

6. The method of claim 1, wherein the bitrate configuration information includes the maximum allowable bitrate.

7. The method of claim 1, further comprising:
determining a bitrate of data transmitted in the QoS flow; and
on a condition that the bitrate of the data transmitted is greater than the maximum allowable uplink bitrate, discarding at least some data.

8. The method of claim 1, further comprising:
receiving, from the RAN, a handover request, including an indication that uplink rate control for the QoS flow is deactivated; and
adjusting, based on the indication, one or more application layer parameters associated with an application mapped to the QoS flow.

9. The method of claim 8, wherein the handover request indicates if a target RAN supports uplink rate control.

10. The method of claim 9, further comprising:
reactivating uplink rate control for the QoS flow upon completion of a handover from the RAN to a target RAN.

11. A wireless transmit / receive unit (WTRU) comprising:
a transceiver; and
a processor;
wherein the transceiver and processor are configured to:
receive, from a session management function (SMF), one or more quality of service (QoS) rules associated with a QoS flow, wherein the one or more QoS rules include an indication that that uplink rate control is supported for the QoS flow and bitrate configuration information associated with the QoS flow;
receive, from a radio access network (RAN), a message indicating that uplink rate control is activated for the QoS flow;
determine a maximum allowable uplink bitrate for the QoS flow;
adjust, based on the maximum allowable uplink bitrate, one or more application layer parameters associated with an application mapped to the QoS flow.

12. The WTRU of claim 11, wherein the one or more QoS rules include an application identifier that identifies an application associated with the QoS flow.

13. The WTRU of claim 12, wherein the application identifier indicates that all traffic associated with the identified application is mapped to the QoS flow.

14. The WTRU of claim 11, wherein the bitrate configuration information includes a plurality of bitrate values and corresponding index values.

15. The WTRU of claim 11, wherein the message received from the RAN includes the maximum allowable bitrate or an index value.

16. The WTRU of claim 11, wherein the bitrate configuration information includes the maximum allowable bitrate.

17. The WTRU of claim 11, wherein the processor is further configured to:
determine a bitrate of data transmitted in the QoS flow; and
on a condition that the bitrate of the data transmitted is greater than the maximum allowable uplink bitrate, discard at least some data.

18. The WTRU of claim 11, wherein the transceiver and processor are further configured to:
receive, from the RAN, a handover request, including an indication that uplink rate control for the QoS flow is deactivated; and
adjust, based on the indication, one or more application layer parameters associated with an application mapped to the QoS flow.

19. The WTRU of claim 18, wherein the handover request indicates if a target RAN supports uplink rate control.

20. The WTRU of claim 19, wherein the transceiver and processor are further configured to:
reactivate uplink rate control for the QoS flow upon completion of a handover from the RAN to a target RAN.
